(19) United States
(12) Patent Application Publication
(10) Pub. No.: US 2015/0331254 A1
(43) Pub. Date: Nov. 19, 2015

(54) MULTIFOCAL OPHTHALMIC LENS

(71) Applicant: ESSILOR INTERNATIONAL (COMPAGNIE GENERALE D'OPTIQUE, Chrenton-le-pont (FR)

(72) Inventor: Cyril GUILLOUX, Charenton Le Pont (FR)

(21) Appl. No.: 14/758,077

(22) PCT Filed: Dec. 31, 2013
(86) PCT No.: PCT/EP2013/078167

§ 371 Date: Jun. 26, 2015

(30) Foreign Application Priority Data
Dec. 31, 2012 (EP) 12306715.9

(51) Int. Cl. G02C 7/06; G02C 7/02

(52) U.S. Cl. CPC G02C 7/063; G02C 7/068; G02C 7/027; G02C 2202/06

(57) ABSTRACT

A multifocal ophthalmic lens, comprising a far vision (“FV”) area and a near vision (“NV”) area. When a value attained by subtracting the refractive power of said FV area from the refractive power of said NV area is an addition power Add, an average surface power D11 of said FV area and an average surface power D12 of the NV area of a surface on a side of the object (“front surface”), and an average surface power D21 of said FV area and an average surface power D22 of a surface on a side of the eye (“back surface”), satisfy the relationship D21−D22=Add−(D12−D11), wherein D11 and D12 satisfy the relationship D12-D11>Add, wherein said front surface has a toric component with a cylinder value greater than 0.25 D in modulus; and wherein said front surface has an inflection point and/or a plateau.

### RELATED APPLICATIONS

This is a U.S. national stage application under 35 USC §371 of application No. PCT/EP2013/078167, filed on Dec. 31, 2013. This application claims the priority of European application no. 12306715.9 filed Dec. 31, 2012, the entire content of which is hereby incorporated by reference.

### FIELD OF THE INVENTION

The invention relates to a multifocal ophthalmic lens and to a method for determining a multifocal ophthalmic lens.

### BACKGROUND OF THE INVENTION

A person who wears eyeglasses (“wearer”) for vision correction may be prescribed a positive or negative optical power correction. For presbyopic wearers (i.e. having a progressively diminished capacity to focus on near objects), the value of the power correction is different for far vision and near vision.

Ophthalmic lenses suitable for presbyopic wearers are multifocal lenses with areas having different refraction values that can occur in discrete steps (e.g. bifocal, trifocal) between a far-vision area (“FV area”) and a near-vision area (“NV area”), or in a smooth transition as a multifocal surface (progressive) in which the refractivity changes progressively between the FV area and the NV area.

The prescription thus comprises a far-vision power value and an addition (“Add”) representing the dioptric power increment between far vision and near vision. The addition power Add indicates the difference of refractive power between the FV area and the NV area. The prescription for an individual wearer thus comprises a far-vision power value for the FV area and the Add representing the dioptric power increment between far vision and near vision.

The prescription can also include a correction for astigmatism. The blurred vision resulting from the wearers's astigmatism is due to the inability of the optics of the wearer's eye to focus a point object into a sharp focused image on the retina due, for example, to toric curvature of the cornea. Astigmatism of the rays forming the image on the retina can also be due to aberration caused by the multifocal lens.

For example, with a conventional progressive multifocal lens, the curvature changes according to each area of at least one of the lens surfaces. An astigmatic aberration, or unwanted astigmatism, is caused because a difference of curvature is created between the x direction (the direction that is horizontal when the eyeglass is worn) and the y direction (the direction that is vertical along the lens perpendicular to the x direction), crossing from FV area to the NV area.

A wearer not having prescribed astigmatism can obtain clear vision without perceiving so much the fading of an image if the astigmatic aberration appearing in the lens is 1.0 diopters or less, preferably 0.5 diopters or less. Therefore, in a progressive multifocal lens, a comparatively wide clear-vision region having an astigmatic aberration of 1.0 diopters or less, or preferably 0.5 diopters or less, is placed in the FV area in which the range of eye movement is great.

The ophthalmic prescription can include a prescribed astigmatism correction. Such a prescription is produced by the ophthalmologist in the form of a pair of values formed by an axis value (in degrees) and an amplitude value (in diopters). The amplitude value, also referred to herein as “modulus,” represents the difference between minimal and maximal power in a given direction. The mean power (relative to the mean sphere SM in terms of prescription) is the arithmetical average of the smallest power and the highest power.

### SUMMARY OF THE INVENTION

One aspect of the invention relates to a multifocal ophthalmic lens for viewing an object via an eye of an eyeglass wearer, comprising:

a far vision (“FV”) area having a refractive power; and

a near vision (“NV”) area having a refractive power which is different from the refractive power of the FV area, such that when a value attained by subtracting the refractive power of said FV area from the refractive power of said NV area is an addition power Add, an average surface power D11 of said FV area of a surface on a side of the object (“front surface”) and an average surface power D12 of the NV area of the front surface, and an average surface power D21 of said FV area of a surface on a side of the eye (“back surface”) and an average surface power D22 of the NV area of the back surface, satisfy the relationship D21−D22=Add−(D12−D11),

wherein said average surface power D11 and said average surface power D12 satisfy the relationship D12−D11>Add,

wherein said front surface has a toric component with a cylinder value greater than 0.25 D in modulus; and

wherein said front surface has an inflection point and/or a plateau.

According to further embodiments which can be considered alone or in combination:
the multifocal lens has a progressive area in which the refractive power changes progressively between said FV and NV areas; and/or
D12−D11=4.0 D; and/or
the front surface is non-rotationally symmetrical; and/or
the front surface has an axis of symmetry; and/or
the toric component on said front surface is equal to at least part of the wearer's prescription correction for astigmatism; and/or
the toric component on said front surface fully provides the wearer's prescription correction for astigmatism; and/or
the back surface is a progressive surface with an inflection point and/or a plateau.

Another aspect of the invention relates to a method for determining a multifocal ophthalmic lens for viewing an object via an eye of an eyeglass wearer, and comprising a far vision (“FV”) area having a refractive power, and a near vision (“NV”) area having a refractive power which is different from the refractive power of the FV area, such that when a value attained by subtracting the refractive power of said FV area from the refractive power of said NV area is an addition power Add, an average surface power D11 of said FV area of a surface on a side of the object (“front surface”) and an average surface power D12 of the NV area of the front surface, and an average surface power D21 of said FV area of a surface on a side of the eye (“back surface”) and an average surface power D22 of the NV area of the back surface, satisfy the relationship D21−D22=Add−(D12−D11), wherein the method comprises the steps of:

determining the average surface power D11 and the average surface power D12 to satisfy the relationship D12−D11>Add;

determining a toric component on the front surface having a cylinder value greater than 0.25 D in modulus; and

determining an inflection point and/or a plateau on the front surface.

Another aspect of the invention relates to a computer program product comprising one or more stored sequences of instruction that is accessible to a processor and which, when executed by the processor, causes the processor to carry out the steps of the method according to the invention.

Another aspect of the invention relates to a computer readable medium carrying out one or more sequences of instructions of the computer program product of the invention.

Another aspect of the invention relates to a set of data comprising data relating to a first surface of a lens determined according to the method of the invention.

Another aspect of the invention relates to a method for manufacturing a progressive ophthalmic lens, comprising the steps of:

providing data relative to the eyes of a wearer;

transmitting data relative to the wearer;

determining a first surface of a lens according to the method of the invention;

transmitting data relative to the first surface;

carrying out an optical optimization of the lens based on the transmitted data relative to the first surface;

transmitting the result of the optical optimization; and

manufacturing the progressive ophthalmic lens according to the result of the optical optimization.

Another aspect of the invention also to a set of apparatuses for manufacturing a progressive ophthalmic lens, wherein the apparatuses are adapted to carry out steps of the method according to the invention.

Features and advantages of the invention will appear from the following description of embodiments of the invention, given as non-limiting examples, with reference to the accompanying drawings listed hereunder.

### BRIEF DESCRIPTION OF THE DRAWINGS

FIGS. 1 and 2 show the schematic structure of a progressive multifocal lens, wherein FIG. 1 is an elevational view showing the schematic structure, and FIG. 2 is a cross-sectional view following the main line of sight;

FIG. 3 shows a power profile, for the front surface of a lens (total prescription: SPH+2, CYL+2, AXIS 45°, ADD=2.5; front surface: ADD=4), of the deviation along the main meridian of the mean sphere value, minimum sphere value and maximum sphere value from the sphere value at reference point x=0, y=+8 mm;

FIG. 4 shows a front surface mean sphere map for the entire front lens surface of the lens, of the deviation of the mean sphere value from the sphere value at reference point x=0, y=+8 mm according to lens represented in FIG. 3;

FIG. 5 shows a front surface cylinder map for the lens represented in FIG. 3;

FIG. 6 shows a back surface power profile, for the back surface of the lens represented in FIGS. 3-5, of the deviation along the main meridian of the mean sphere value, minimum sphere value and maximum sphere value from the sphere value at reference point x=0, y=+8 mm;

FIG. 7 shows a back surface mean sphere map for the entire back lens surface of the lens, of the deviation of the mean sphere value from the sphere value at reference point x=0, y=+8 mm according to the lens represented in FIG. 6;

FIG. 8 shows a back surface cylinder map for the lens represented in FIG. 6;

FIG. 9 shows a map of unwanted astigmatism (i.e. front and back surface combination) for the lens as represented in FIGS. 3-8;

FIG. 10 shows a front surface power profile, for the front surface of a lens (total prescription: SPH+2, CYL+2, AXIS 45°, ADD=2.5; front surface: ADD=4, CYL+2, AXIS 45°), of the deviation along the main meridian of the mean sphere value, minimum sphere value and maximum sphere value from the sphere value at reference point x=0, y=+8 mm;

FIG. 11 shows a front surface mean sphere map for the entire front lens surface of the lens, of the deviation of the mean sphere value from the sphere value at reference point x=0, y=+8 mm according to lens represented in FIG. 10;

FIG. 12 shows a front surface cylinder map for the lens represented in FIG. 10;

FIG. 13 shows a back surface power profile, for the back surface of the lens represented in FIGS. 10-12, of the deviation along the main meridian of the mean sphere value, minimum sphere value and maximum sphere value from the sphere value at reference point x=0, y=+8 mm;

FIG. 14 shows a back surface mean sphere map for the entire back lens surface of the lens, of the deviation of the mean sphere value from the sphere value at reference point x=0, y=+8 mm according to the lens represented in FIG. 13;

FIG. 15 shows a back surface cylinder map for the lens represented in FIG. 13;

FIG. 16 shows a map of unwanted astigmatism (i.e. front and back surface combination) for the lens as represented in FIGS. 10-15;

FIG. 17 shows a front surface power profile, for the front surface of a lens (total prescription: SPH −2, ADD=2.5; front surface: ADD=4), of the deviation along the main meridian of the mean sphere value, minimum sphere value and maximum sphere value from the sphere value at reference point x=0, y=+8 mm;

FIG. 18 shows a front surface mean sphere map for the entire front lens surface of the lens, of the deviation of the mean sphere value from the sphere value at reference point x=0, y=+8 mm according to lens represented in FIG. 17;

FIG. 19 shows a front surface cylinder map for the lens represented in FIG. 17;

FIG. 20 shows a back surface power profile, for the back surface of the lens represented in FIGS. 17-19, of the deviation along the main meridian of the mean sphere value, minimum sphere value and maximum sphere value from the sphere value at reference point x=0, y=+8 mm;

FIG. 21 shows a back surface mean sphere map for the entire back lens surface of the lens, of the deviation of the mean sphere value from the sphere value at reference point x=0, y=+8 mm according to the lens represented in FIG. 20;

FIG. 22 shows a back surface cylinder map for the lens represented in FIG. 20;

FIG. 23 shows a map of unwanted astigmatism (i.e. front and back surface combination) for the lens as represented in FIGS. 17-22;

FIG. 24 shows a front surface power profile, for the front surface of a lens (total prescription: SPH −2, ADD=2.5; front surface: ADD=4, CYL+2, AXIS 90°), of the deviation along the main meridian of the mean sphere value, minimum sphere value and maximum sphere value from the sphere value at reference point x=0, y=+8 mm;

FIG. 25 shows a front surface mean sphere map for the entire front lens surface of the lens, of the deviation of the mean sphere value from the sphere value at reference point x=0, y=+8 mm according to lens represented in FIG. 24;

FIG. 26 shows a front surface cylinder map for the lens represented in FIG. 24;

FIG. 27 shows a back surface power profile, for the back surface of the lens represented in FIGS. 24-26, of the deviation along the main meridian of the mean sphere value, minimum sphere value and maximum sphere value from the sphere value at reference point x=0, y=+8 mm;

FIG. 28 shows a back surface mean sphere map for the entire back lens surface of the lens, of the deviation of the mean sphere value from the sphere value at reference point x=0, y=+8 mm according to the lens represented in FIG. 27;

FIG. 29 shows a back surface cylinder map for the lens represented in FIG. 27;

FIG. 30 shows a map of unwanted astigmatism (i.e. front and back surface combination) for the lens as represented in FIGS. 24-29;

FIG. 31 shows a map of unwanted astigmatism superimposing FIGS. 23 and 30;

FIG. 32 illustrates a flowchart of an example of a method for determining a progressive ophthalmic lens;

FIG. 33 shows an apparatus for implementing the method of FIG. 33; and

FIG. 34 illustrates a flowchart of another example of a method for determining a progressive ophthalmic lens.

### DETAILED DESCRIPTION OF THE DRAWINGS

In the sense of the invention, the wording “the front surface has an inflection point” means that at least along the main line of the multifocal ophthalmic lens the average surface power of the front surface of the multifocal ophthalmic lens has at least on inflection point. An inflection point being defined as a point on a curve at which the tangent crosses the curve at that point.

The main line, also referred to as meridian line, links an upper edge and a lower edge of the lens, passing successively through the far vision control point, the fitting cross, the prism reference point and the near vision control point.

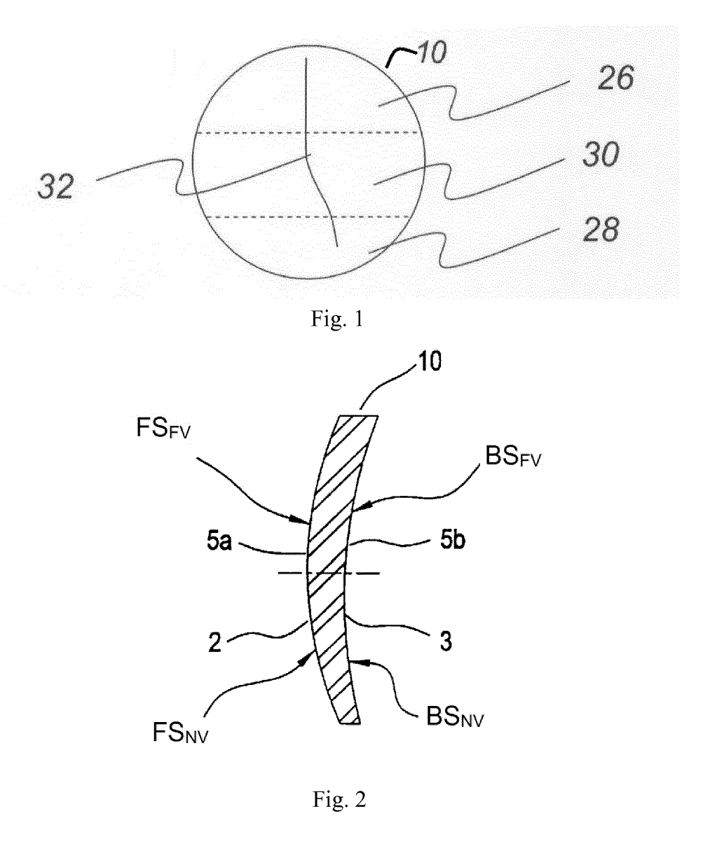

FIGS. 1 and 2 show a multifocal lens 10 as an example of a multifocal lens provided at its upper portion with a FV area 26, which is a visual field area for viewing objects at a far distance, and provided below with a NV area 28, which is a visual field area for viewing objects at a near distance, and having a refractive power different from that of the FV area 26. For illustrative purposes in explaining the invention, the following description will apply to a progressive multifocal lens. However, it must be understood that the invention is not limited thereto.

Progressive multifocal lens 10 is provided with progressive refractive surfaces 5a and 5b on the front surface (“FS”) 2 on the side of the object and the back surface (“BS”) 3 on the side of the eye, respectively. The FV area 26 and NV area 28 are connected by a progressive area 30 in which the refractive power changes continuously. As shown in FIG. 2, the progressive multifocal lens 10 is a multifocal lens in which the average surface power of the FV area 26 on the side of the object is FS_{FV}, the average surface power of the NV area 28 is FS_{NV}, the average surface power of the FV area 26 on the side of the eye is BS_{FV}, the average surface power of the NV area is BS_{NV}, and the addition power Add of the NV area 28 in relation to the FV area 26 is defined by the following:

BS_{FV}−BS_{NV}=Add−(FS_{NV}−FS_{FV}) (1)

In accordance with an aspect of the invention, the difference of average surface power FS_{FV} of the FV area 26 on the side of the object and the average surface power FS_{NV} of the NV area on the side of the object is greater than the addition power Add, which is expressed as:

FS_{NV}−FS_{FV}>Add (2)

This feature provides the benefit of higher magnification in the NV area to assist the wearer in, for example, focusing on small objects and reading fine print.

In one particular embodiment of the present invention, the Add on the side of the object is 4.0 D

A more detailed explanation of this enhanced magnification feature is as follows. The magnification SM of a lens is generally represented by the following equation.

SM=Mp*Ms (3)

Mp is the power factor, and Ms is the shape factor. If distance from the vertex L is the distance to the eye from the vertex (inner vertex) of the surface of the lens on the side of the eye, Po is the refractive power (inner vertex power) of the lens, t is the center thickness of the lens, n is the refractivity of the lens, and Pb is the refractive power (base curve) of the surface of the lens on the side of the object, these values are represented as follows.

Mp=1/(1−L*Po) (4)

Ms=1/(1−(t*Pb)/n) (5)

In the computation of Equations (4) and (5), diopters (D) are used for the refractive power of the lens Po and the refractive power of the surface on the side of the object Pb, and meters (m) are used for distance L and thickness t. As is clear from these equations, in a multifocal lens, the magnification SM1 of the FV area and the magnification SM2 of the NV area differ because the refractive power Po differs between the FV area and the NV area. The size of an image visualized by the wearer also differs according to this difference of magnification.

The magnifications of the FV area 26 and NV area 28 of the progressive multifocal lens 10 of the present example become as follows when the magnifications SM1 and SM2 of the respective visual field areas are sought by applying Equations (3), (4) and (5) described above to the FV area 26 and NV area 28. First, the magnification SM1 of the FV area 26 is expressed as follows.

SM1=Mp1*Ms1 (9)

Mp1 is the power factor of the FV area, Ms1 is the shape factor of the FV area, and these values become as follows when considering that the surface power Pb appears as the average surface power FS_{FV} of the surface 2 on the side of the object.

Mp1=1/(1−L*Po) (10)

Ms1=1/(1−(t/n)*FS_{FV}) (11)

In the same manner, the magnification SM2 of the NV area 28 is expressed as follows.

SM2=Mp2*Ms2 (12)

Mp2=1/(1−L*(Po+Add)) (13)

Ms2=1/(1−(t/n)*FS_{NV}) (14)

Mp2 is the power factor of the NV area, Ms2 is the shape factor, surface power Pb appears in the average surface power FS_{NV} of the surface 2 on the side of the object, and the refractive power of the NV area 28 is the value having added the addition power Add to the refractive power of the FV area 26.

The following comparison between the present invention and conventional lenses will demonstrate the enhanced near vision magnification SM2 provided by the present invention. The following parameters apply for a conventional lens:

The distance from the vertex L is set to 13.00 mm (L=0.0130 m)
The center thickness t is set to 3.0 mm (t=0.0030 m)
The refractivity n is set to 1.67 (n=1.67)
The power of the lens Po is 0.0 D

### The Add is 2.50 D

The average surface power FS_{FV} of the FV area is 3.75 D
The average surface power FS_{NV} of the NV area is 3.75+2.50=6.25 D

With the above values, the near vision magnification SM2 is as follows:

SM2=1.045

Another example of a conventional progressive multifocal lens has a spherical front surface and the prescription is provided entirely on the back surface. For this lens, because the average surface power FS_{NV} of the NV area is 3.75+0=3.75 D, the near vision magnification SM2 is as follows:

SM2=1.041

As stated above, one embodiment of the present invention provides for an Add of 4.00 D on the side of the object. Then, if FS_{NV} of the NV area is 3.75+4.00=7.75 D, the near vision magnification SM2 is as follows:

SM2=1.048

Thus, the enhanced near vision magnification SM2 provided by the progressive multifocal lens in accordance with an embodiment of the present invention is readily apparent.

Another aspect of the invention relates to the correction of astigmatism. In particular, certain advantages are attained by forming a toric area on the front surface of the lens. The following examples will illustrate this.

### Example 1

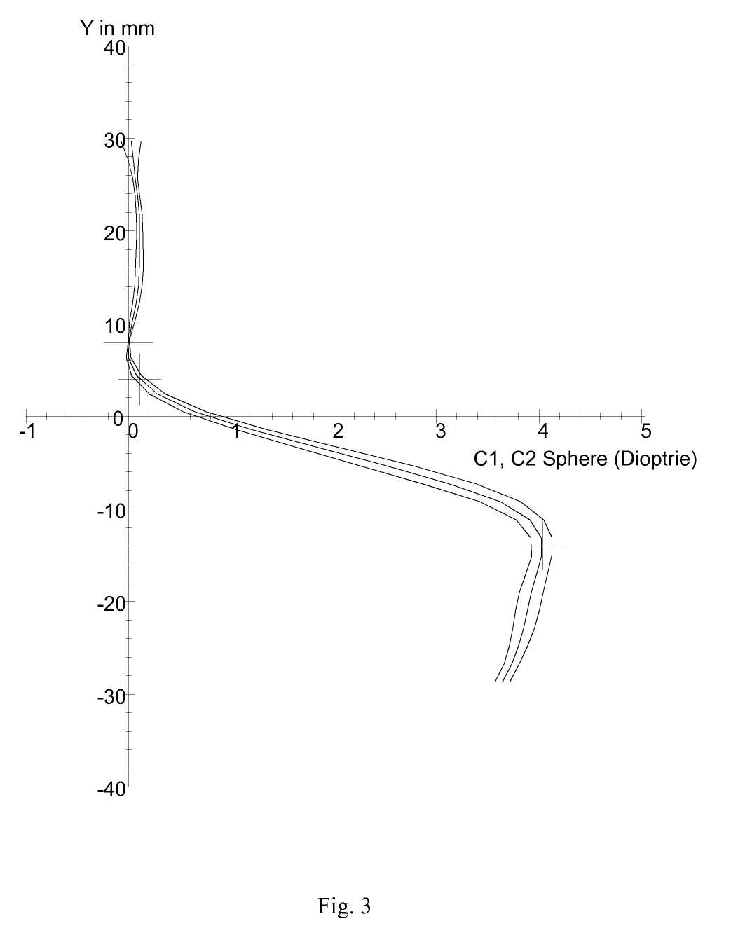

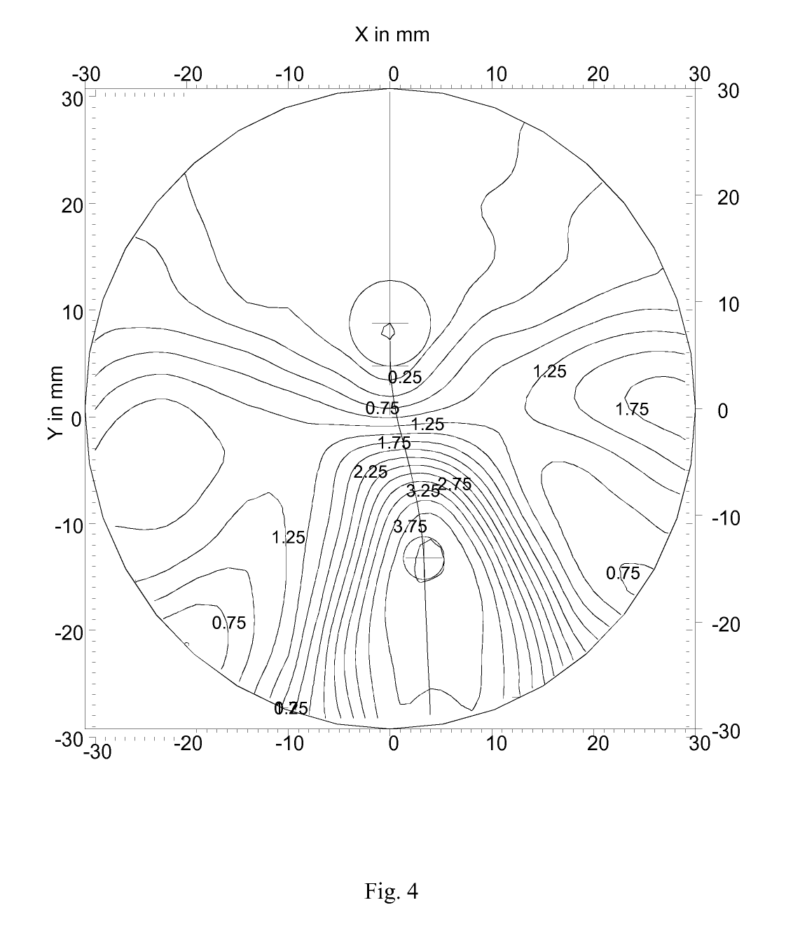

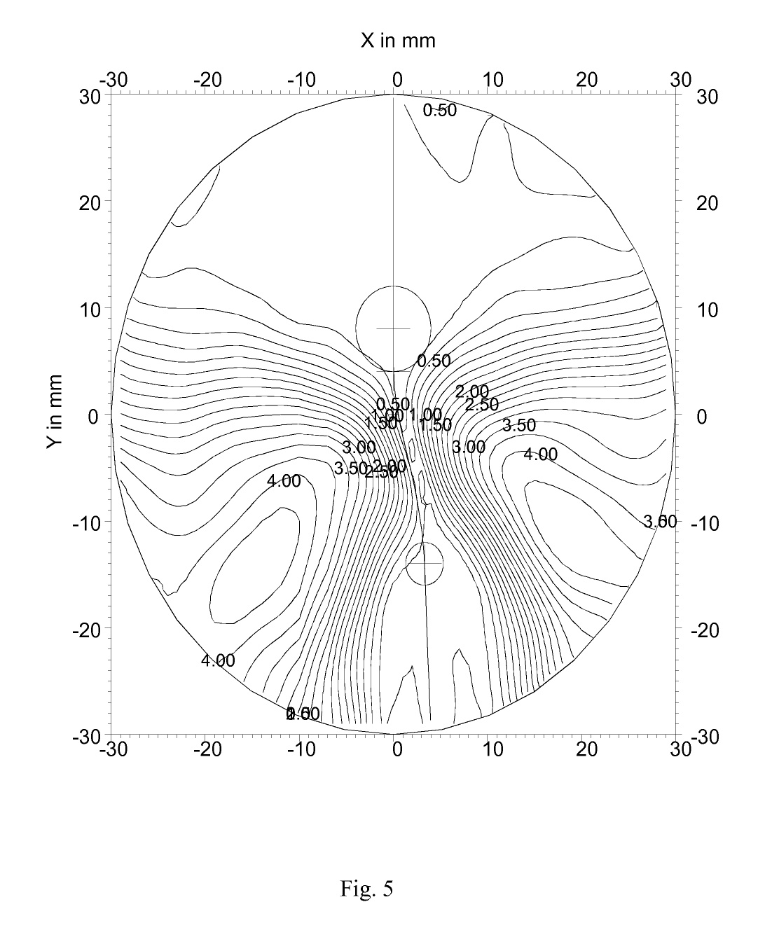

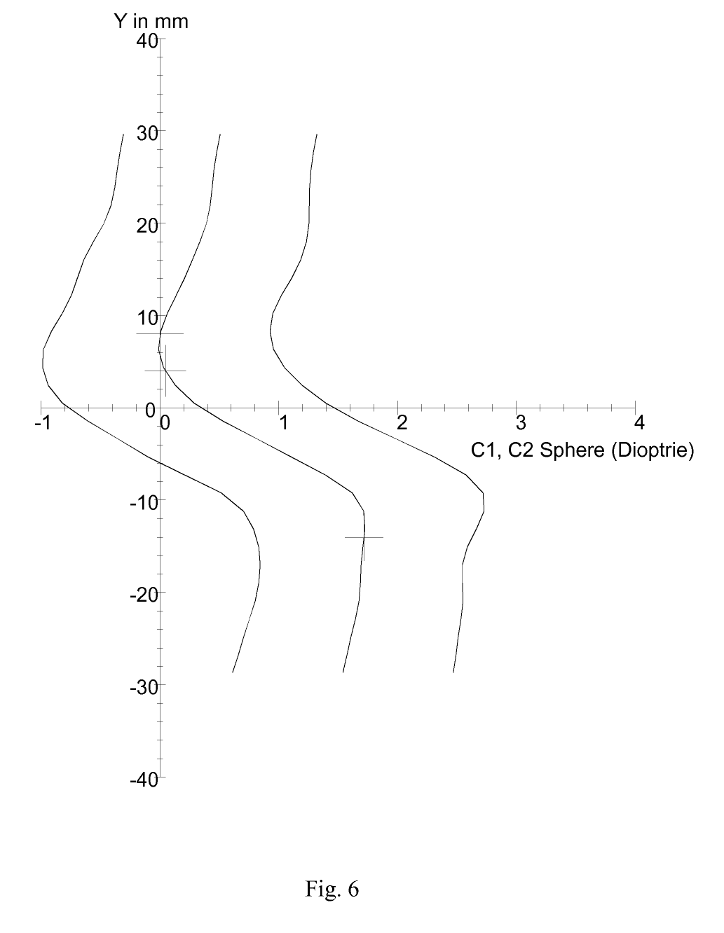

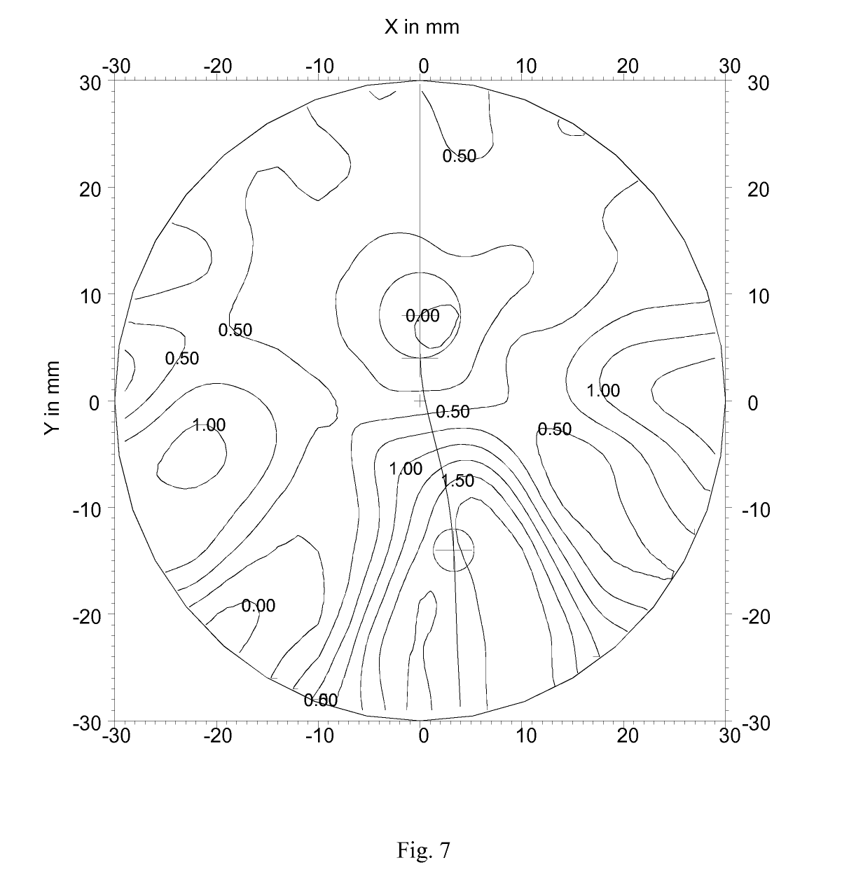

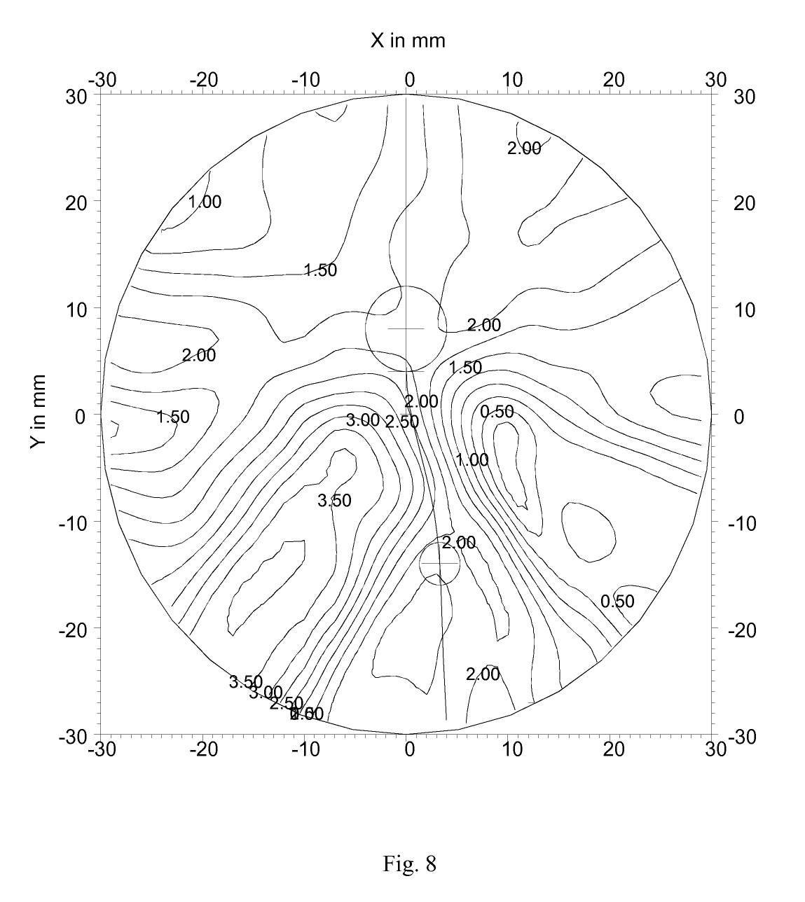

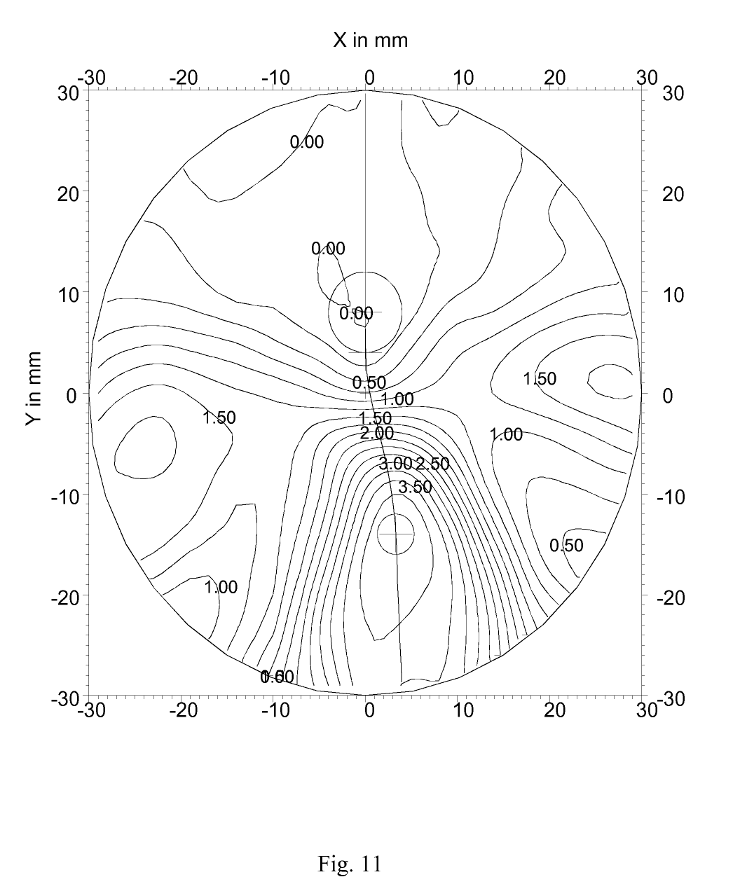

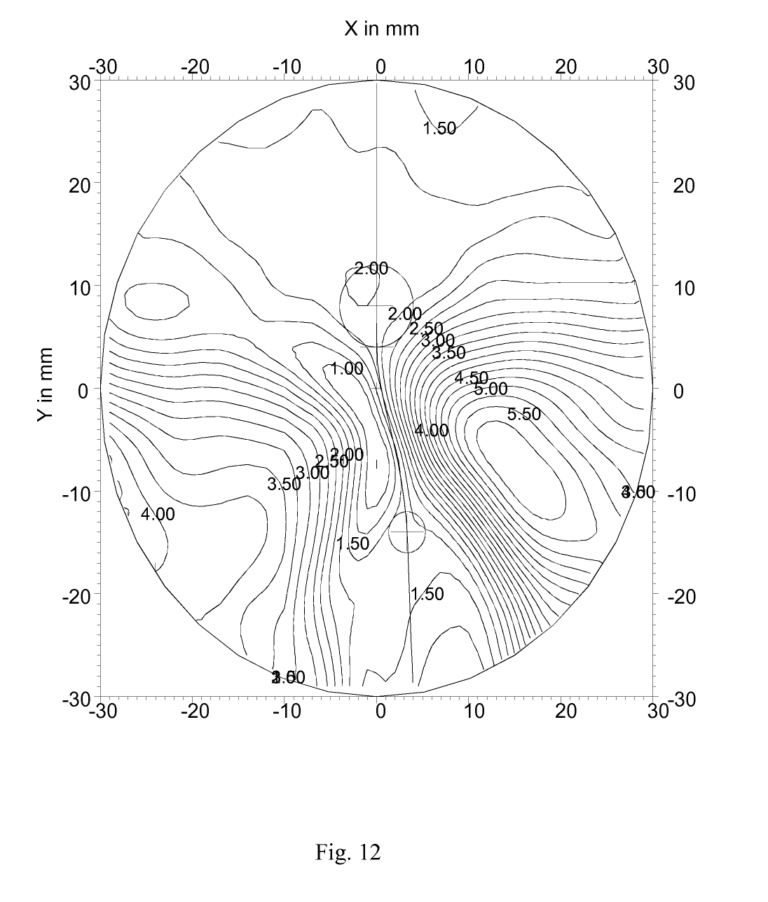

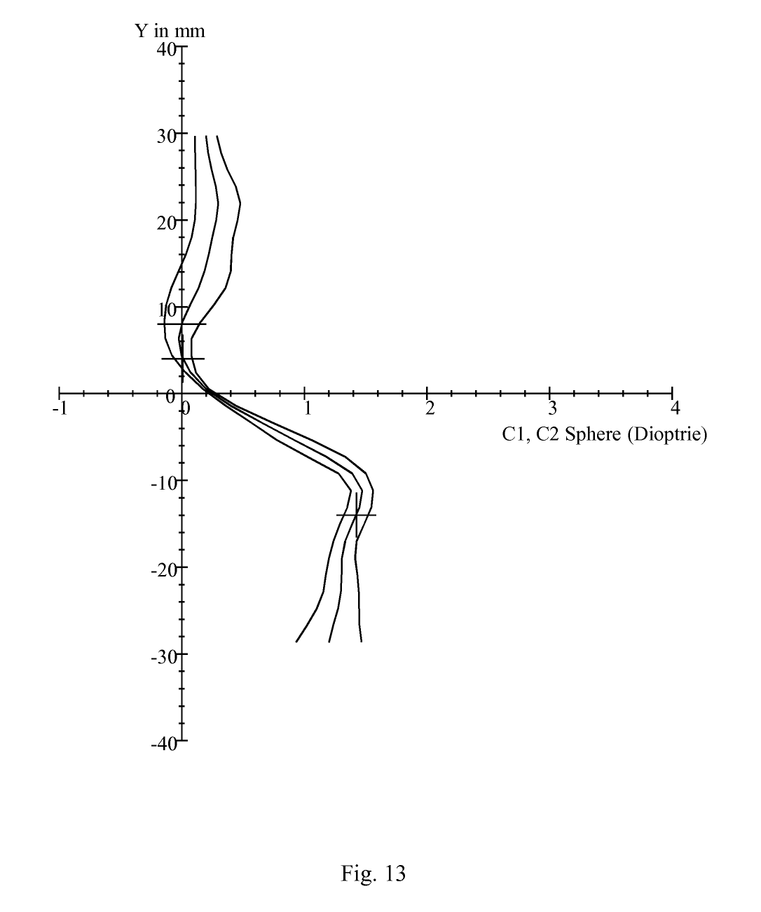

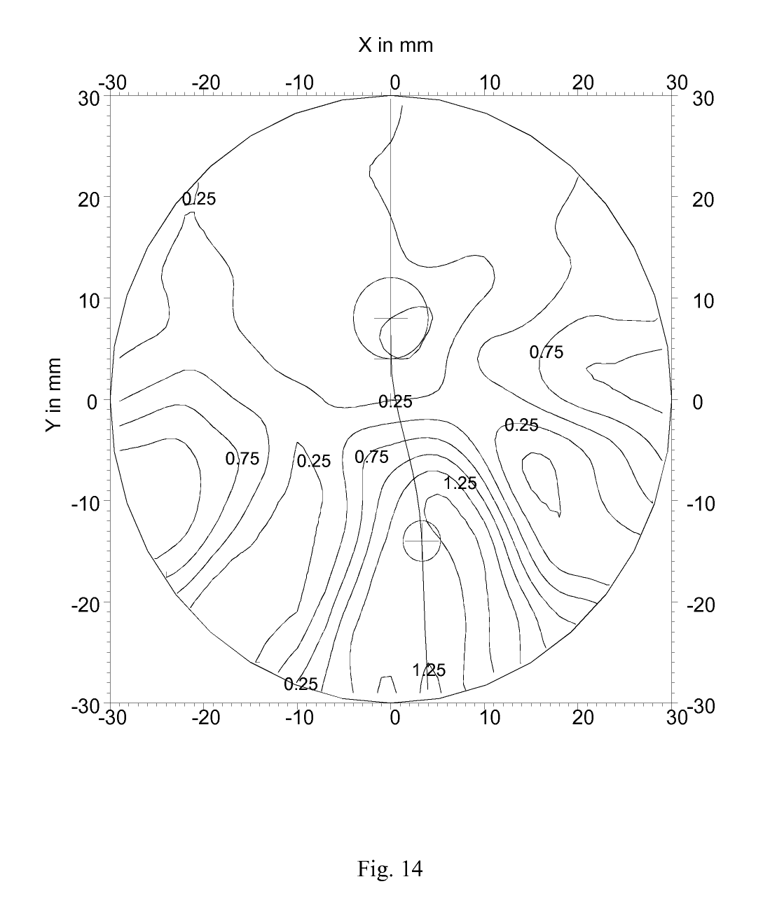

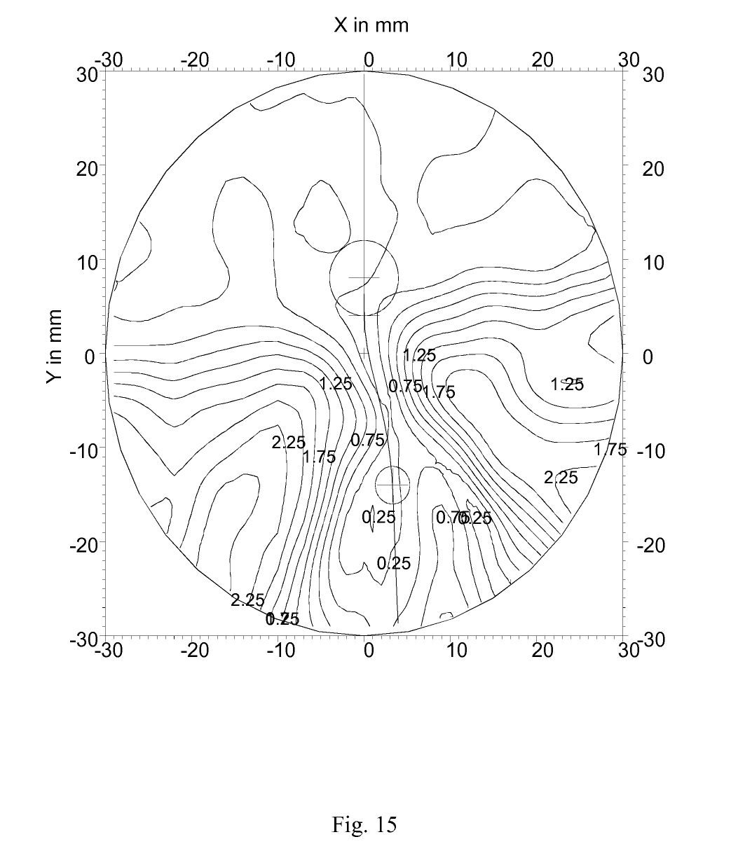

The first example is shown in FIGS. 3 to 16. The prescription for the wearer is SPH +2.0, CYL+2, axis 45°, and Add of 2.5. A surface Add of 4.0 is applied to the front surface. FIGS. 3 to 9 show a first implementation of this prescription which forms the toric area on the back surface to provide the entire astigmatism correction.

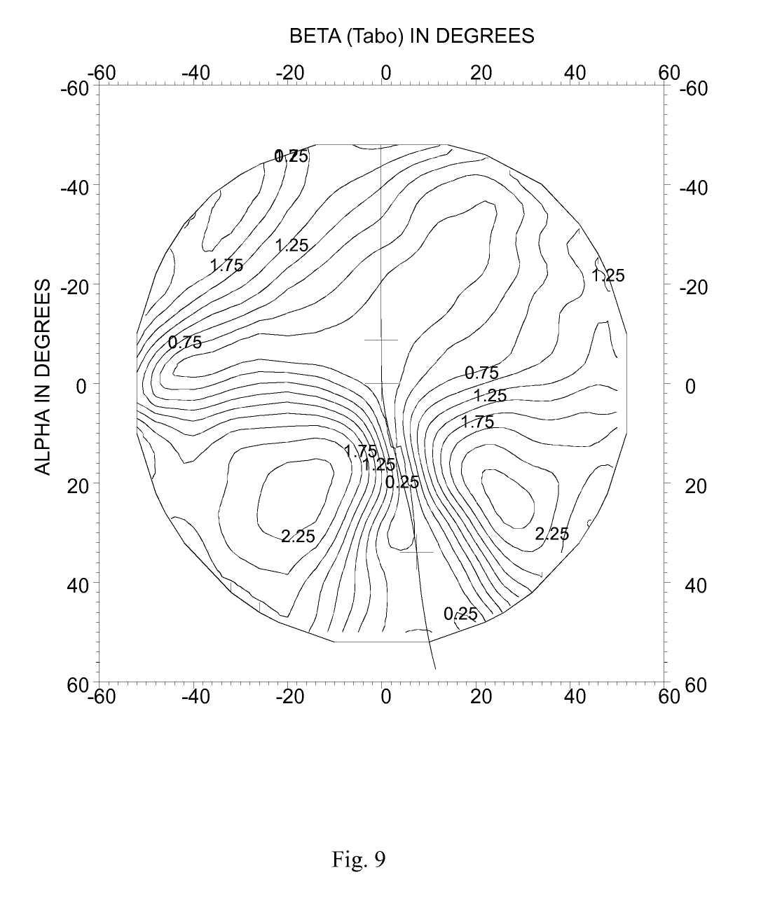

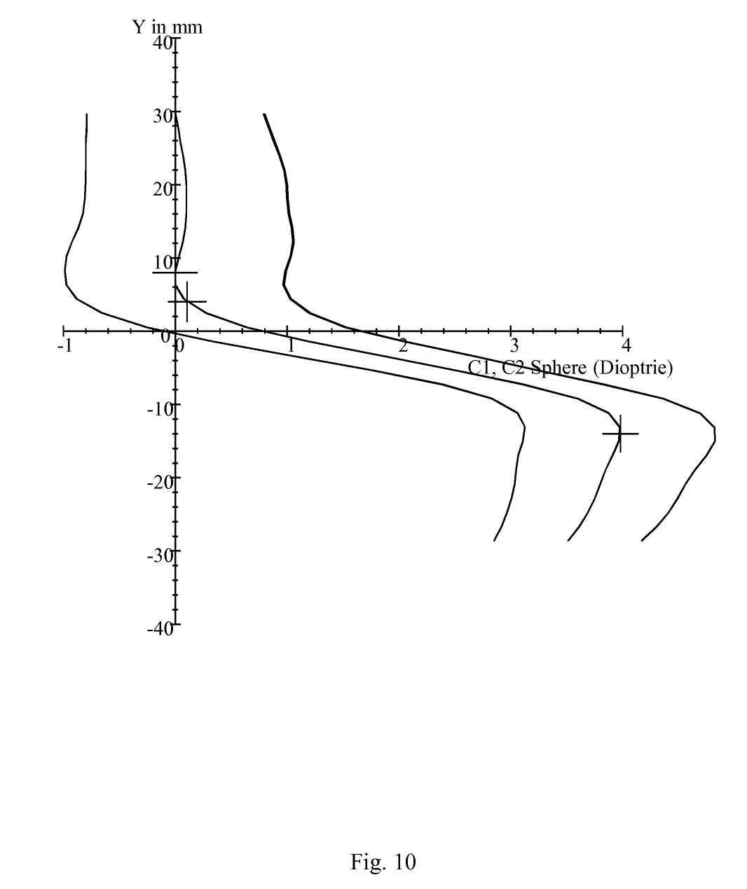

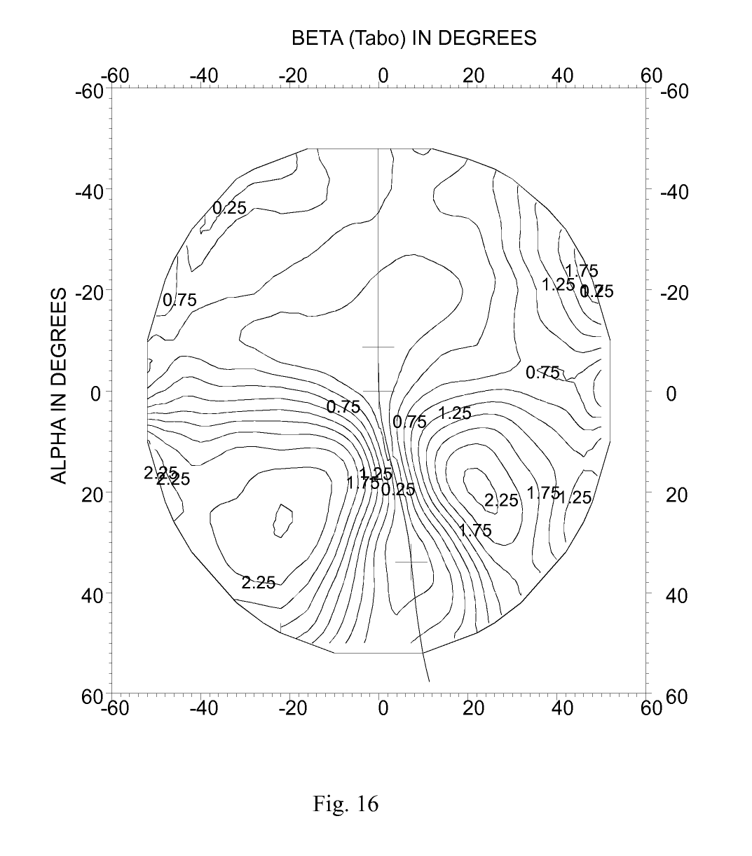

FIGS. 10 to 16 show a second implementation of this prescription which forms the toric area on the front surface to provide the entire astigmatism correction. From a comparison of FIGS. 9 and 16, it is clearly evident that the unwanted astigmatism is reduced in FIG. 16 relative to FIG. 9. This is because according to the Tscherning rule, the front surface curvature (“surface power”) has an effect on the optical aberrations. For each lens power there is a corresponding optimal surface power. Accordingly, for a prescribed astigmatism, a front surface having a toric component corresponding (in module and axis) to the prescribed astigmatism provides an effect in the right direction according to the Tscherning rule (i.e. highest surface power in the direction of the highest lens power).

### Example 2

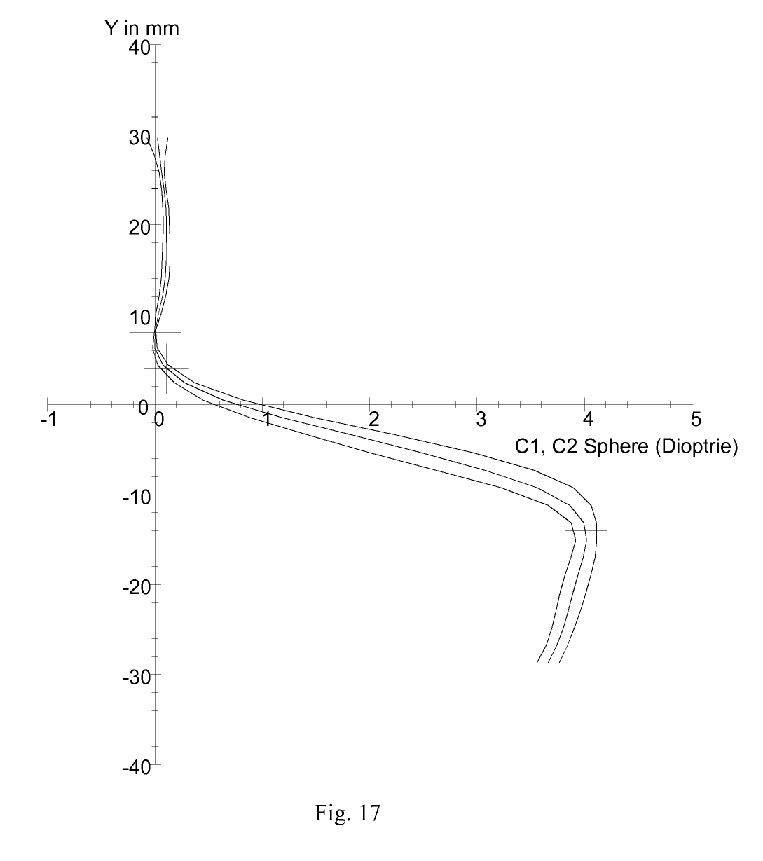

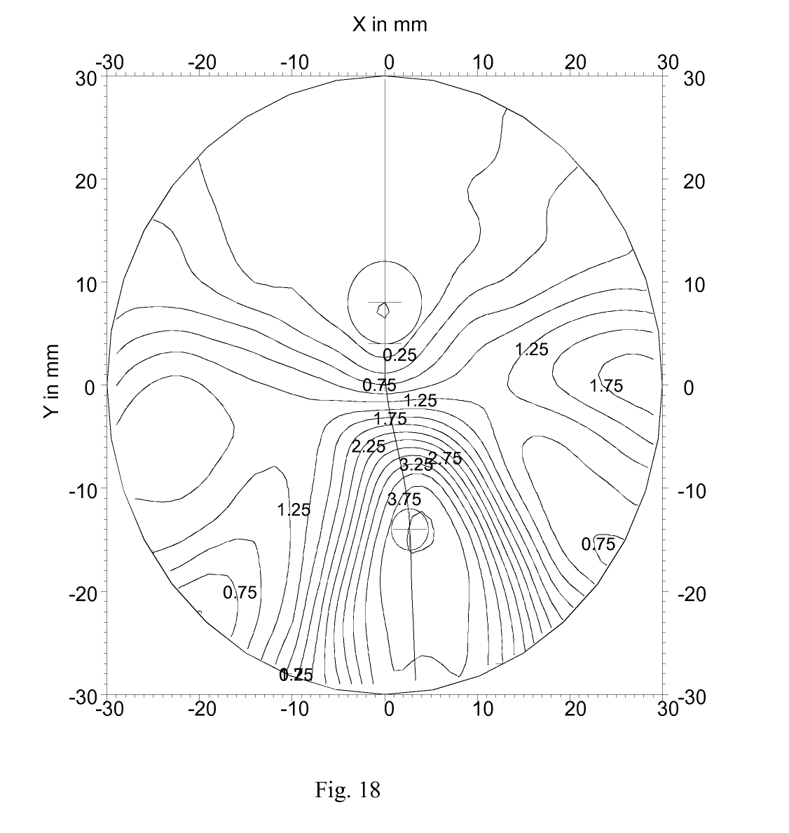

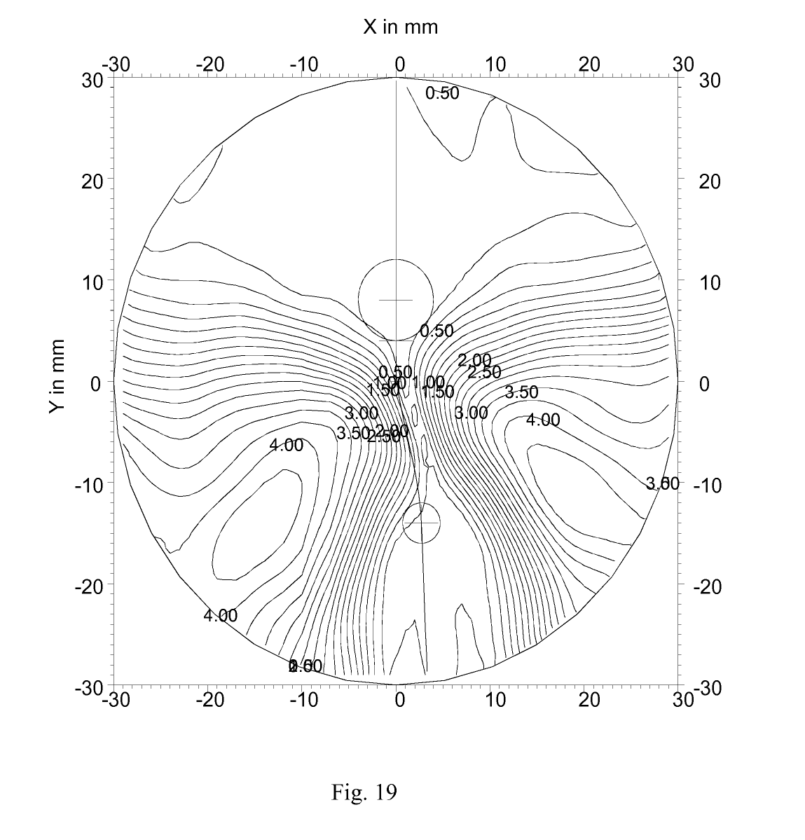

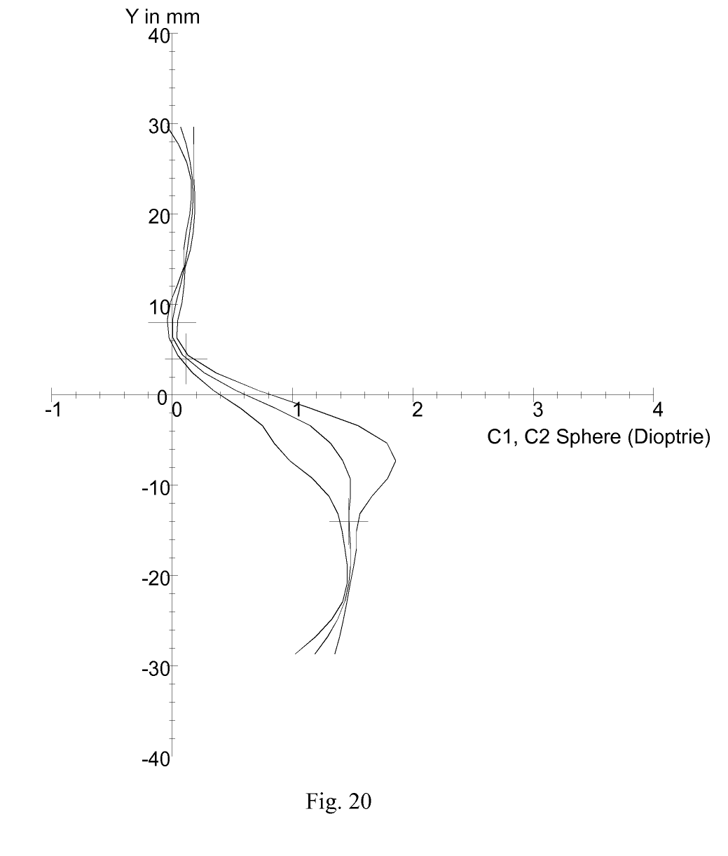

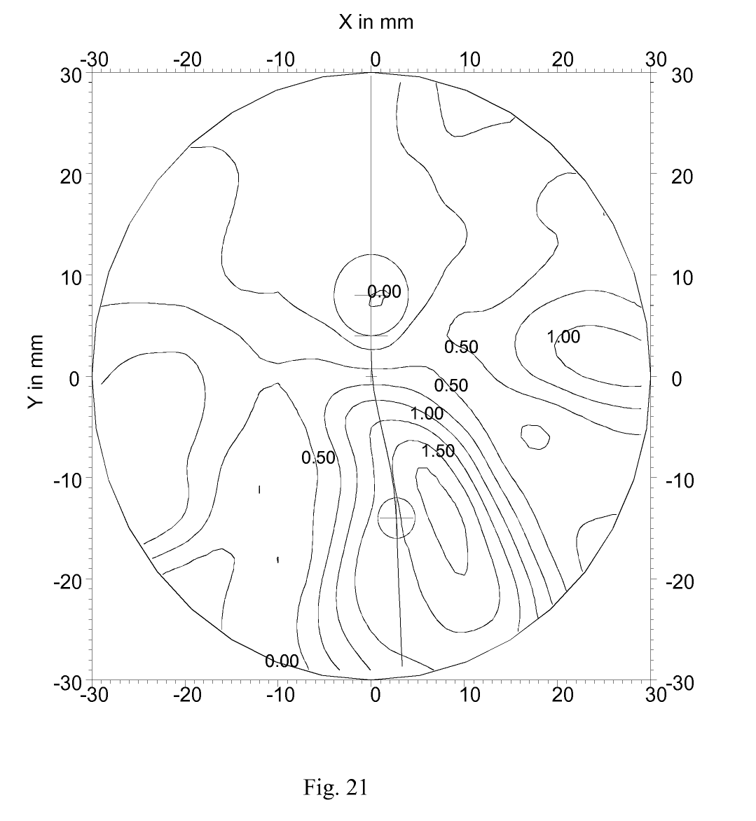

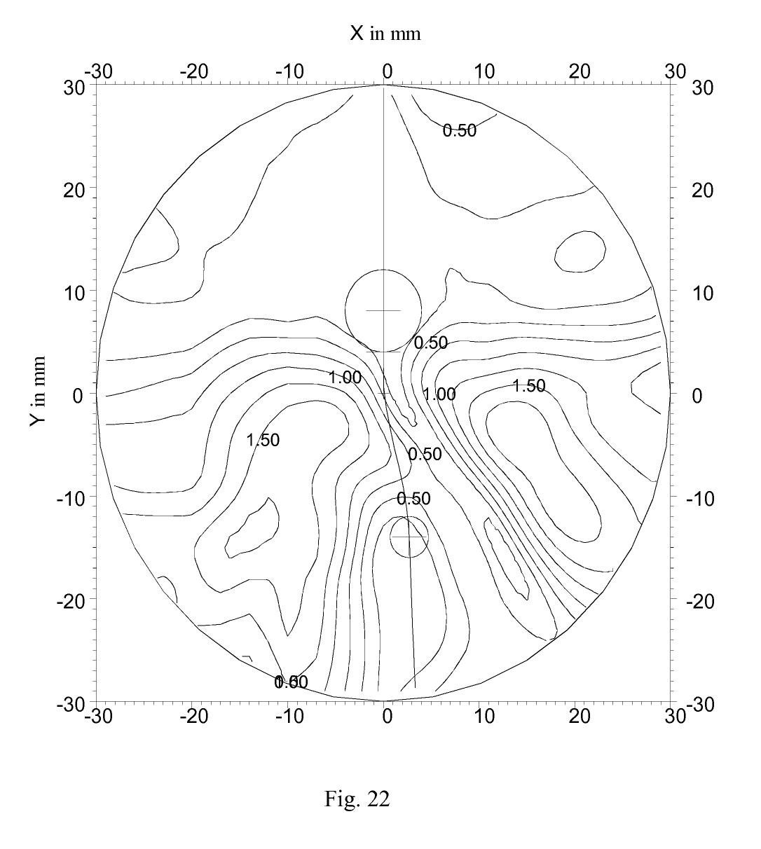

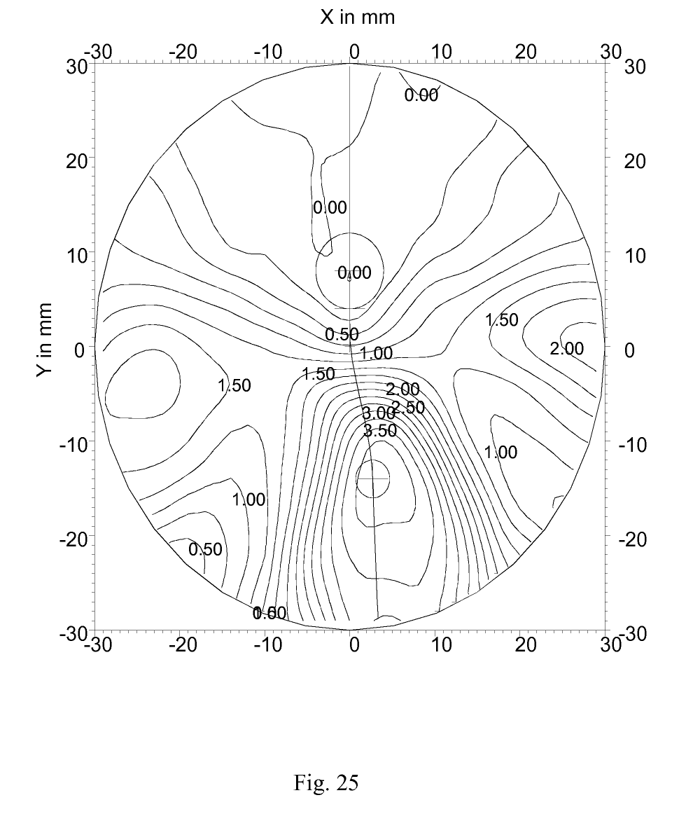

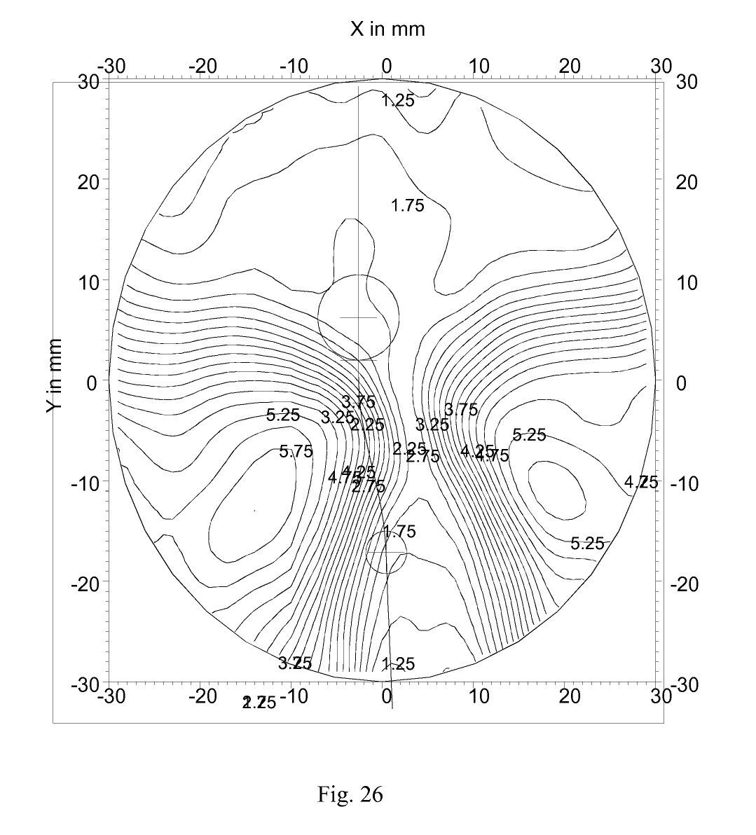

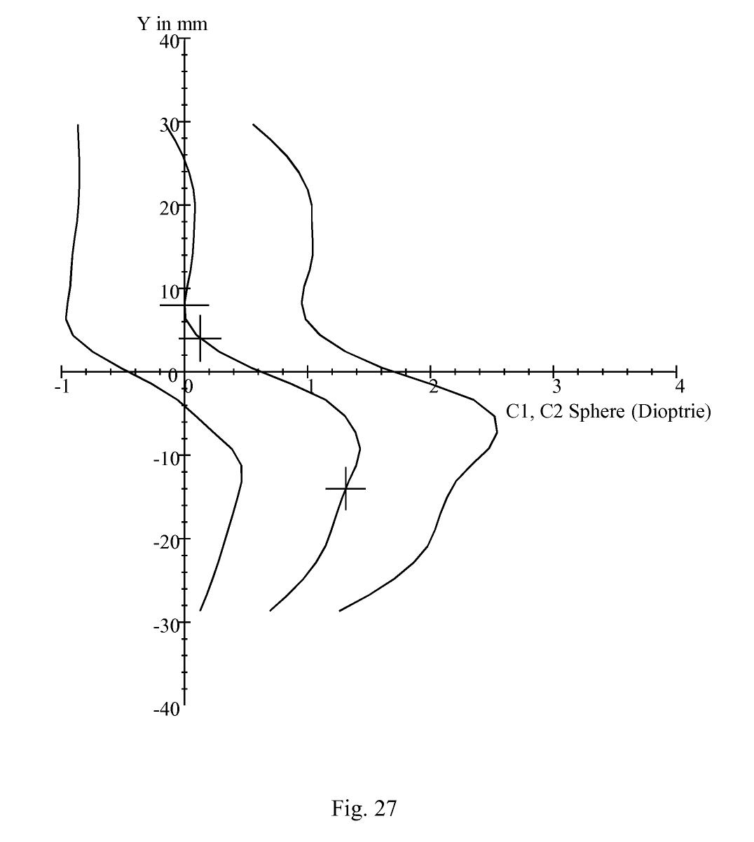

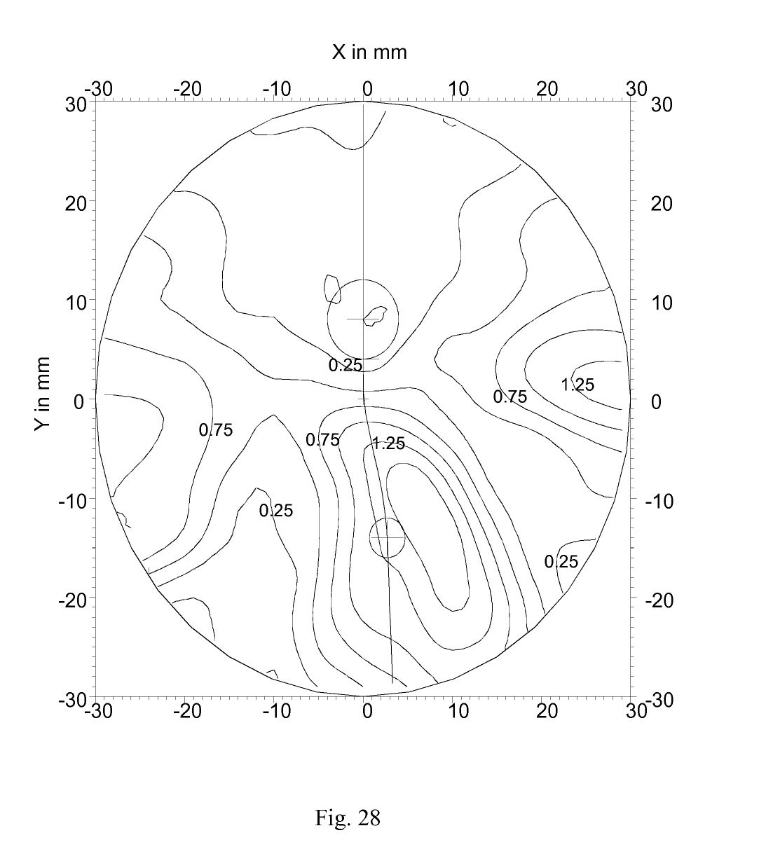

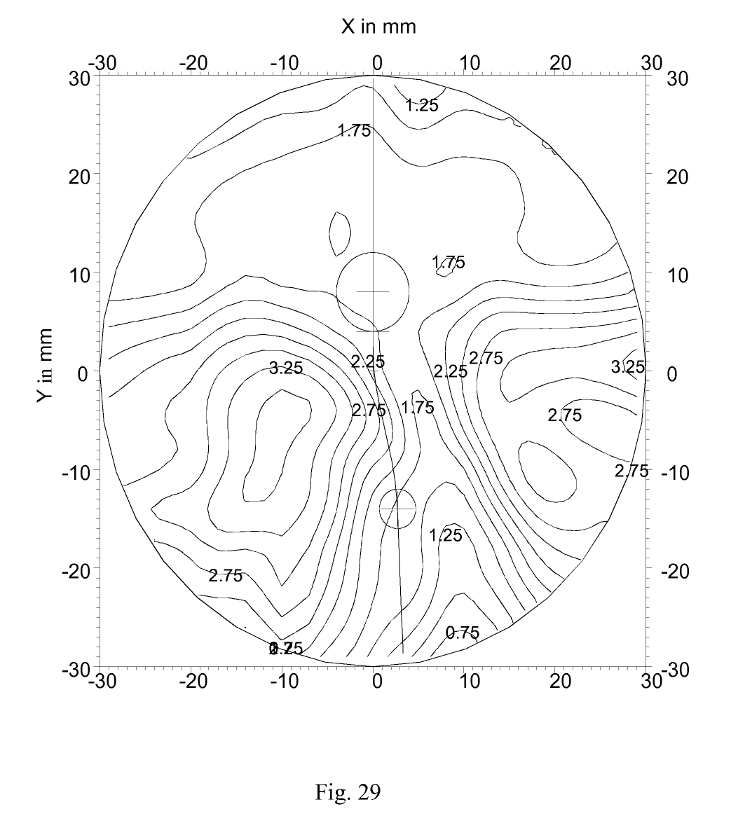

The second example is shown in FIGS. 17 to 30. The non-astigmatic prescription for the wearer is SPH −2.0, and Add of 2.5. A surface Add of 4.0 is applied to the front surface. FIGS. 17 to 23 show a first implementation of this non-astigmatic prescription.

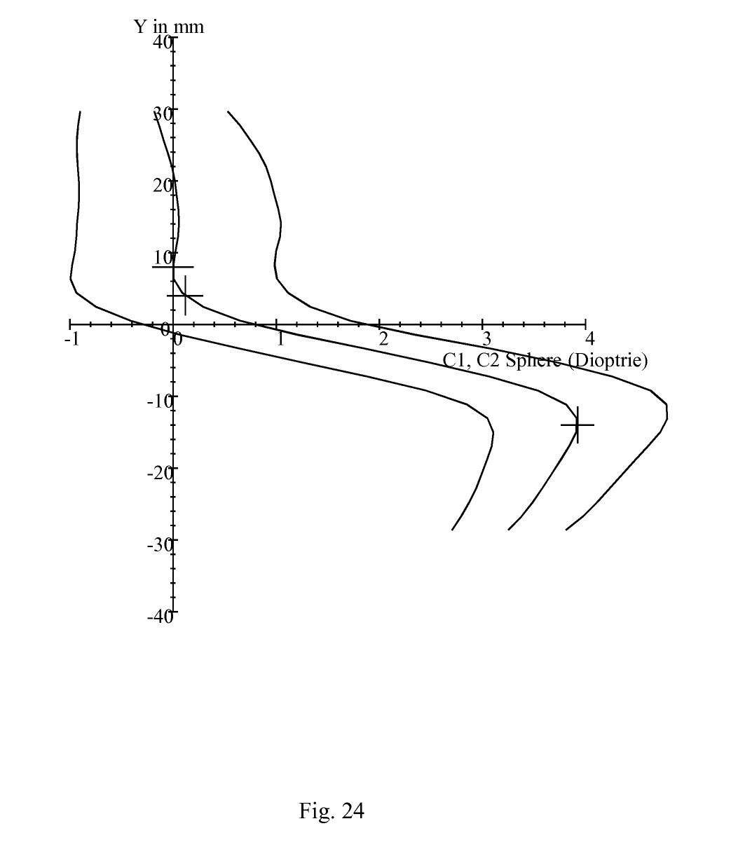

FIGS. 24 to 30 show a second implementation which adds to this non-astigmatic prescription a toric area on the front surface of CYL+2 and axis 90°.

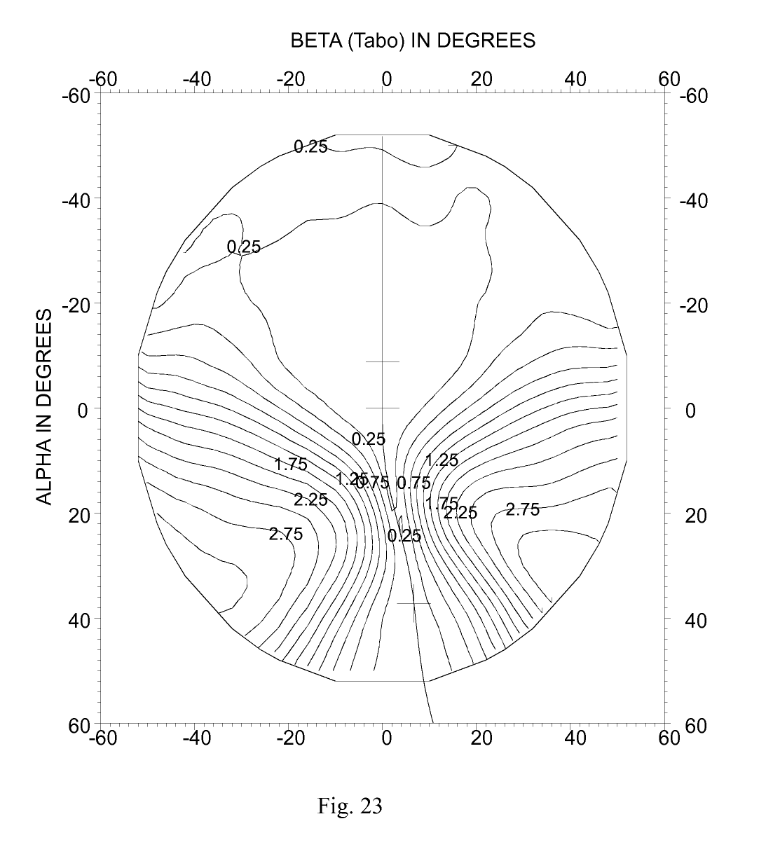

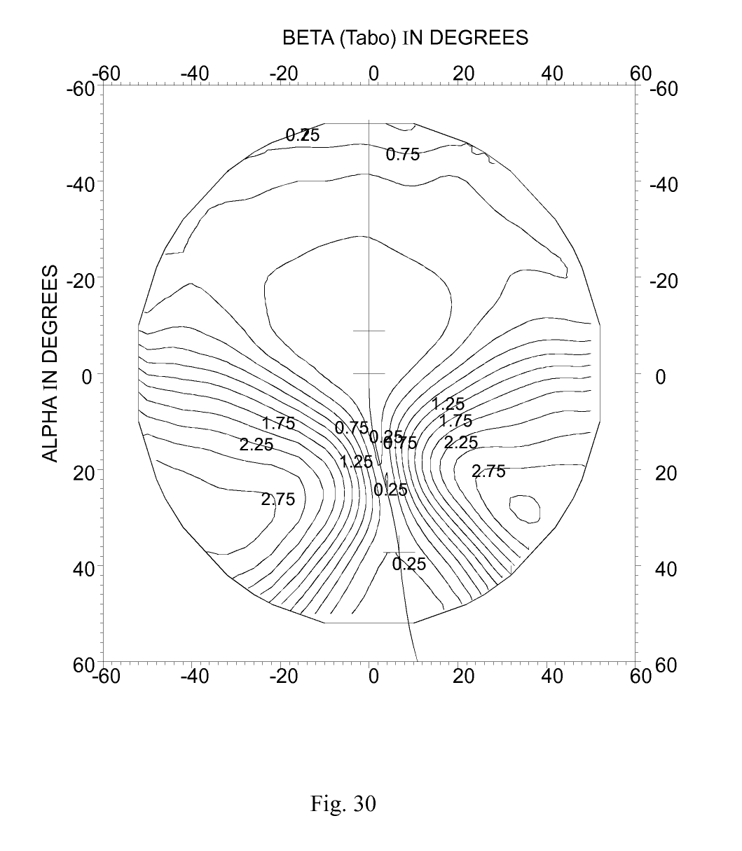

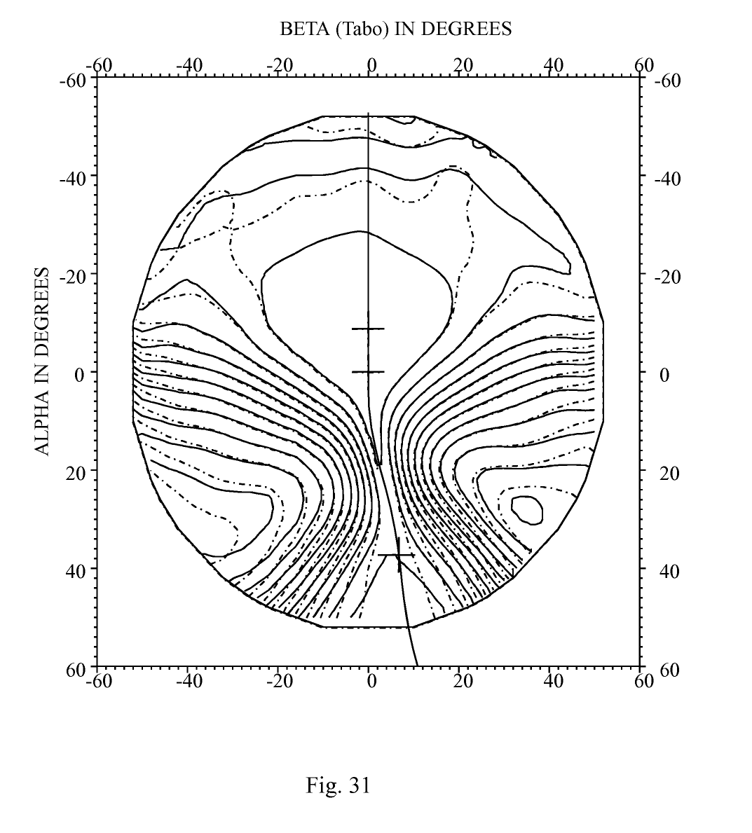

FIG. 31 is an overlap of FIGS. 23 and 30. The dotted lines represent FIG. 23, i.e. the example without the toric component, whereas the solid lines represent FIG. 30, i.e. the example with a toric component added to the front surface. As is readily apparent from FIG. 31, due to power variation and power distribution over the lens, as a whole, lens power is different in different directions. Then, a toric component applied on the whole front surface of the lens can partially compensate some optical aberrations.

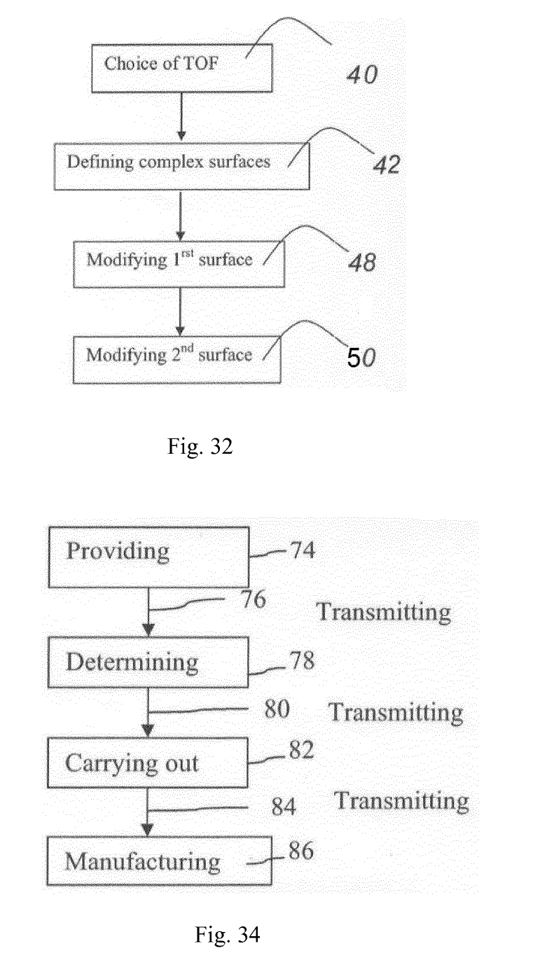

FIG. 32 illustrates a flowchart of an example of a method for determining a progressive ophthalmic lens. In this embodiment, the method comprises the step 40 of choosing a target optical function (“TOF”) suited to the wearer. As known, to improve the optical performances of an ophthalmic lens, methods for optimizing the parameters of the ophthalmic lens are thus used. Such optimization methods are designed so as to get the optical function of the ophthalmic lens as close as possible to a predetermined target optical function.

The target optical function represents the optical characteristics the ophthalmic lens should have. In the context of the present invention and in the remainder of the description, the term “target optical function of the lens” is used for convenience. This use is not strictly correct in so far as a target optical function has only a sense for a wearer—ophthalmic lens and ergorama system. Indeed, the optical target function of such system is a set of optical criteria defined for given gaze directions. This means that an evaluation of an optical criterion for one gaze direction gives an optical criterion value. The set of optical criteria values obtained is the target optical function. The target optical function then represents the performance to be reached. In the simplest case, there will only be one optical criterion such as optical power or astigmatism; however, more elaborate criteria may be used such as acuity drop which can be estimated thanks to a combination of optical power and astigmatism. Optical criteria involving aberrations of higher order may be considered. The number of criteria N considered depends on the precision desired. Indeed, the more criteria considered, the more the lens obtained is likely to satisfy the wearer's needs. However, increasing the number N of criteria may result in increasing the time taken for calculation and the complexity to the optimization problem to be solved. The choice of the number N of criteria considered will then be a trade-off between these two requirements. More details about target optical functions, optical criteria definition and optical criteria evaluation can be found in patent application EP-A-2 207 118.

The method also comprises a step 42 of defining a first aspherical surface of the lens and a second aspherical surface of the lens. For instance, the first surface is an object side (or front) surface and the second surface is an eyeball side (or back) surface. Each surface has in each point a mean sphere value SPHₘₑₐₙ, a cylinder value CYL and a cylinder axis γ_{AX}.

The method further comprises a step 50 of modifying the second aspherical surface so as to reach the target optical function for the lens and guarantee an optimum sharpness for the lens. The modifying of the second surface is carried out by optical optimization for minimizing the difference between a current optical function and the target optical function with a cost function. A cost function is a mathematical quantity expressing the distance between two optical functions. It can be expressed in different ways according to the optical criteria favored in the optimization. In the sense of the invention, “carrying out an optimization” should preferably be understood as “minimizing” the cost function. Of course, the person skilled in the art will understand that the invention is not limited to a minimization per se. The optimization could also be a maximization of a real function, according to the expression of the cost function which is considered by the person skilled in the art. Namely “maximizing” a real function is equivalent to “minimizing” its opposite. With such conditions 1 and 2, the lens obtained (such as the one on FIGS. 10 to 16) thus exhibits reduced aberrations while guaranteeing the target optical function, the target optical function being defined to provide an optimal sharpness of the image to the wearer. Such effect can be qualitatively understood by the fact that the values and orientation of the curvatures for the first surface are modified which implies that the impact on the magnification of the lens is modified, resulting in an increasing comfort in near vision. In other words, the geometry of the first surface is chosen so that the comfort of the wearer in near vision is increased. The second surface is determined to ensure optimal optical performances impacting the sharpness of the image.

Steps 48 and 50 of modifying the first and second surfaces can be carried out by toggling between first and second surfaces with a first target optical function associated to the front surface dedicated to increasing magnification and a second target optical function associated to the back surface dedicated to ensuring sharpness of the lens. Such toggling between first and second surfaces optimization is described for instance in EP-A-2 207 118, the content of which is hereby incorporated herein by reference.

A computer program product comprising one or more stored sequence of instruction that is accessible to a processor and which, when executed by the processor, causes the processor to carry out the steps of the method is also proposed.

Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus. A computer-readable medium carrying one or more sequences of instructions of the computer program product is thus proposed. This enables to carry out the method in any location.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

Many apparatuses or processes may be used to obtain the pair of lenses using a first surface of a lens determined according to the method previously described. The processes often imply an exchange of a set of data. For instance, this set of data may comprise only the first surface of a lens determined according to the method. This set of data may preferably further comprise data relating to the eyes of the wearer such that with this set, the progressive ophthalmic lens can be manufactured.

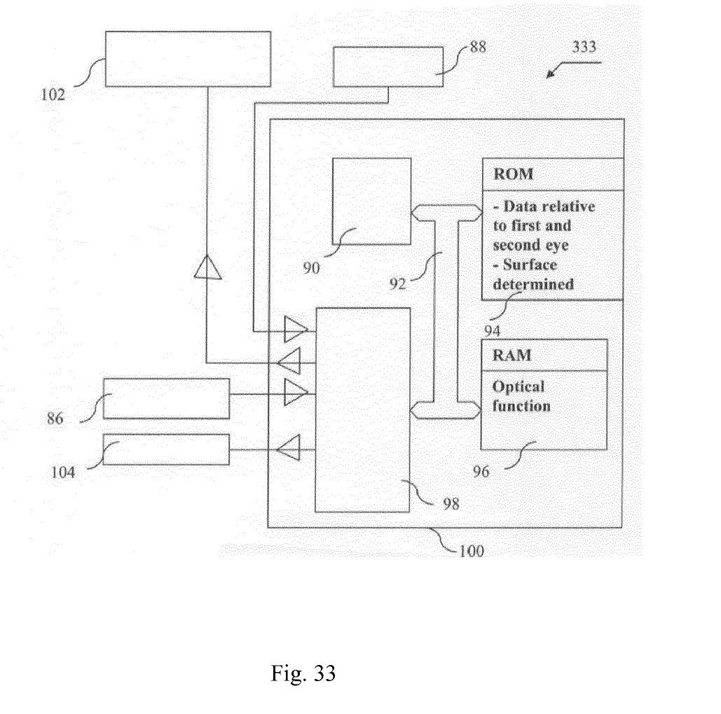

This exchange of data may be schematically understood by the apparatus of FIG. 33 which represents an apparatus 333 for receiving numerical data. It comprises a keyboard 88, a display 104, an external information center 86, a receiver of data 102, linked to an input/output device 98 of an apparatus for data processing 100 which is realized there as a logic unit.

The apparatus for data processing 100 comprises, linked between them by a data and address bus 92:
a central processing unit 90;
a RAM memory 96,
a ROM memory 94, and
said input/ouput device 98.

Said elements illustrated in FIG. 33 are well known for the person skilled in the art. Those elements are not described any further.

To obtain a progressive ophthalmic lens corresponding to a wearer prescription, semi-finished ophthalmic lens blanks can be provided by a lens manufacturer to the prescription labs. Generally, a semi-finished ophthalmic lens blank comprises a first surface corresponding to an optical reference surface, for example a progressive surface in the case of progressive addition lenses, and a second unfinished surface. A semi-finished lens blank having suitable optical characteristics, is selected based on the wearer prescription. The unfinished surface is finally machined and polished by the prescription lab so as to obtain a surface complying with the prescription. An ophthalmic lens complying with the prescription is thus obtained.

Other methods for manufacturing may be used. The method according to FIG. 34 is an example. The method for manufacturing comprises a step 74 of providing data relating to the eyes of the wearer at a first location. The data are transmitted from the first location to a second location at the step 76 of the method. The progressive ophthalmic lens is then determined at step 78 at the second location according to the method for determining previously described. The method for manufacturing further comprises a step 80 of transmitting relative to the first surface to the first location. The method also comprises a step 82 of carrying out an optical optimization based on the data relative to the first surface transmitted. The method further encompasses a step of transmitting 84 the result of the optical optimization to a third location. The method further encompasses a step 86 of manufacturing the progressive ophthalmic lens according to the result of the optical optimization.

Such method of manufacturing makes it possible to obtain a progressive ophthalmic lens with a reduced distortion without degrading the other optical performances of the lens.

The transmitting steps 76 and 80 can be achieved electronically. This makes it possible to accelerate the method. The progressive ophthalmic lens is manufactured more rapidly.

To improve this effect, the first location, the second location and the third location may just be three different systems, one devoted to the collecting of data, one to calculation and the other to manufacturing, the three systems being situated in the same building. However, the three locations may also be three different companies, for instance one being a spectacle seller (optician), one being a laboratory and the other one being a lens designer.

Although preferred embodiments of the invention have been disclosed in detail above, it will be apparent to anyone with ordinary skill in the art that various modifications thereto can be readily made. All such modifications are intended to fall within the scope of the present invention as defined by the following claims.

1. A multifocal ophthalmic lens for viewing an object via an eye of an eyeglass wearer, comprising:
a far vision (“FV”) area having a refractive power; and
a near vision (“NV”) area having a refractive power which is different from the refractive power of the FV area, such that when a value attained by subtracting the refractive power of said FV area from the refractive power of said NV area is an addition power Add, an average surface power D11 of said FV area of a surface on a side of the object (“front surface”) and an average surface power D12 of the NV area of the front surface, and an average surface power D21 of said FV area of a surface on a side of the eye (“back surface”) and an average surface power D22 of the NV area of the back surface, satisfy the relationship D21-D22=Add−(D12−D11),
wherein said average surface power D11 and said average surface power D12 satisfy the relationship D12−D11>Add,
wherein said front surface has a toric component with a cylinder value greater than 0.25 D in modulus; and
wherein said front surface has an inflection point and/or a plateau.

2. The multifocal ophthalmic lens according to claim 1, wherein the multifocal lens has a progressive area in which the refractive power changes progressively between said FV and NV areas.

3. The multifocal ophthalmic lens according to claim 1, wherein D12−D11=4.0 D.

4. The multifocal ophthalmic lens according to claim 1, wherein the front surface is non-rotationally symmetrical.

5. The multifocal ophthalmic lens according to claim 1, wherein the front surface has an axis of symmetry.

6. The multifocal ophthalmic lens according to claim 1, wherein the toric component on said front surface is equal to at least part of the wearer's prescription correction for astigmatism.

7. The multifocal ophthalmic lens according to claim 1, wherein the toric component on said front surface fully provides the wearer's prescription correction for astigmatism.

8. The multifocal ophthalmic lens according to claim 2, wherein the back surface is a progressive surface with an inflection point and/or a plateau.

9. A method for determining a multifocal ophthalmic lens for viewing an object via an eye of an eyeglass wearer, and comprising a far vision (“FV”) area having a refractive power, and a near vision (“NV”) area having a refractive power which is different from the refractive power of the FV area, such that when a value attained by subtracting the refractive power of said FV area from the refractive power of said NV area is an addition power Add, an average surface power D11 of said FV area of a surface on a side of the object (“front surface”) and an average surface power D12 of the NV area of the front surface, and an average surface power D21 of said FV area of a surface on a side of the eye (“back surface”) and an average surface power D22 of the NV area of the back surface, satisfy the relationship D21−D22=Add−(D12−D11), wherein the method comprises the steps of:
determining the average surface power D11 and the average surface power D12 to satisfy the relationship D12−D11>Add;
determining a toric component on the front surface having a cylinder value greater than 0.25 D in modulus; and
determining an inflection point and/or a plateau on the front surface.

10. A computer program product comprising one or more stored sequences of instruction that is accessible to a processor and which, when executed by the processor, causes the processor to carry out the steps of claim 9.

11. A computer readable medium carrying out one or more sequences of instructions of the computer program product of claim 10.

12. A set of data comprising data relating to a first surface of a lens determined according to the method of claim 9.

13. A method for manufacturing a progressive ophthalmic lens, comprising the steps of:
providing data relative to the eyes of a wearer;
transmitting data relative to the wearer;
determining a first surface of a lens according to the method of claim 9;
transmitting data relative to the first surface;
carrying out an optical optimization of the lens based on the transmitted data relative to the first surface;
transmitting the result of the optical optimization; and
manufacturing the progressive ophthalmic lens according to the result of the optical optimization.

14. A set of apparatuses for manufacturing a progressive ophthalmic lens, wherein the apparatuses are adapted to carry out steps of the method according to claim 13.
